(19) United States
(12) Patent Application Publication
(10) Pub. No.: US 2026/0015293 A1
(43) Pub. Date: Jan. 15, 2026

(54) CONDUCTIVE CERAMIC COMPOSITES FOR HIGH TEMPERATURE THERMAL ENERGY STORAGE

(71) Applicant: The Regents of the University of California, Oakland, CA (US)

(72) Inventors: Sean Lubner, Berkeley, CA (US); Ravi Prasher, Berkeley, CA (US); Lin Yang, Berkeley, CA (US); Nathaniel Weger, Berkeley, CA (US); Akanksha K. Menon, Berkeley, CA (US); Hanna Breunig, Berkeley, CA (US); Peng Peng, Berkeley, CA (US)

(21) Appl. No.: 19/116,834

(22) PCT Filed: Oct. 2, 2023
(86) PCT No.: PCT/US23/34304

§ 371 Date: Mar. 28, 2025

Related U.S. Application Data
(60) Provisional application No. 63/413,290, filed on Oct. 5, 2022.

(51) Int. Cl. C04B 35/80; C04B 35/64; H01B 1/18

(52) U.S. Cl. CPC C04B 35/80; C04B 35/64; H01B 1/18; C04B 2235/3206; C04B 2235/3232; C04B 2235/3826; C04B 2235/5292; C04B 2235/5427; C04B 2235/5436; C04B 2235/604; C04B 2235/6562; C04B 2235/6565; C04B 2235/6567; C04B 2235/785; C04B 2235/786; C04B 2235/9607

(57) ABSTRACT

This disclosure provides systems, methods, and apparatus related to high-temperature thermal energy storage. In one aspect, a composite material includes a ceramic and graphite flakes dispersed in the ceramic. The ceramic serves as a matrix of the composite material. The ceramic is an oxide, a carbide, a boride, or a nitride. The graphite flakes are about 20 weight % to 35 weight % of the composite material. The composite material has a porosity of about 5% to 40%.

### RELATED APPLICATIONS

This application claims priority to U.S. Provisional Patent Application No. 63/413,290, filed Oct. 5, 2022, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to thermal energy storage materials and more particularly to conductive ceramic composites for high temperature thermal energy storage.

### BACKGROUND

The world will need Terawatt-hours of energy storage to overcome the intermittency of solar and wind power and fully transition to renewable energy. Most existing energy storage technologies, such as electrochemical batteries and pumped hydro, are too expensive for large scale deployment, geographically constrained, or have critical material availability concerns. Further, a significant amount of end-use energy is needed as high temperature (>1,000° C.) thermal energy instead of electricity, especially for industrial processes such as steel, cement, and glass production. The world cannot achieve full decarbonization without also decarbonizing this high temperature industrial process heat.

Recently, high-temperature thermal energy storage (HT-TES) has emerged as a promising solution to these stated issues. These systems store renewable energy in the form of heat up to 1,500° C. and dispatch it either directly as heat or by converting it into electricity using a heat engine (also called Carnot batteries) as shown in FIG. 1. HT-TES possesses several environmental and economic benefits that make it particularly well suited to TWh-scale deployment needed for full decarbonization, including high energy density (>800 kWh/m³), intrinsic safety (heat itself cannot explode), low capital cost (<US$10/kWh), geographic flexibility, and reliance only on Earth abundant materials.

The ideal HT-TES material needs to satisfy a challenging set of simultaneous constraints: good thermal conductivity to reduce temperature gradients and increase power delivery rates, good and temperature-independent electrical conductivity for rapid and stable self-heating, robust mechanical properties that withstand thermal shock and mitigate thermal cycling fatigue, high temperature stability, and non-corrosivity, all while being made from safe and abundant materials.

Scientists have investigated high temperature liquids for HT-TES, such as molten silicon and tin, as molten salts thermally degrade below 1,000° C. However, containing such corrosive liquids over many cycles at extreme temperatures is challenging, and no demonstrated solution currently exists.

Refractory ceramics and clays are inexpensive but require external heaters, increasing system complexity and reducing efficiency. Recently, researchers addressed this issue by doping ceramics to make them electrically conductive, allowing for direct electrical self-heating. However, their conductivity varies widely with temperature, making the material prone to thermal runaway during charging. FIG. 2 summarizes the state of the art. No material in the literature satisfies all HT-TES requirements, leaving this critical need open.

### SUMMARY

One innovative aspect of the subject matter described in this disclosure can be implemented in a composite material including a ceramic and graphite flakes. The ceramic servies as a matrix of the composite material. The ceramic is an oxide, a carbide, a boride, or a nitride. The graphite flakes are dispersed in the ceramic. The graphite flakes are about 20 weight % to 35 weight % of the composite material. The composite material has a porosity of about 5% to 40%.

In some implementations, the ceramic is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TiN, HfN, ZrN, TaN, NbN, and VN. In some implementations, the ceramic is an undoped ceramic. In some implementations, a grain size of the ceramic is about 500 nanometers to 40 microns. In some implementations, grains of the ceramic are joined to adjacent grains of the ceramic at about 110 degrees to 140 degrees.

In some implementations, each graphite flake of the graphite flakes has dimensions of about 10 microns to 800 microns by about 10 microns to 800 microns by about 1 micron to 8 microns.

In some implementations, an average size of a pore in the composite material is less than an average size of the graphite flakes.

In some implementations, the graphite flakes form a random continuous electrically conductive pathway in the composite material.

In some implementations, the composite material has a thermal conductivity of about 2 Watts per meter-Kelvin (W/m-K) to 20 W/m-K. In some implementations, the composite material has an electrical conductivity of about 1500 siemens per meter (S/m) to 3500 siemens per meter. In some implementations, a Vickers hardness of the composite material is greater than about 40 megapascals (MPa). In some implementations, the composite material has a melting temperature higher than about 1500° C.

In some implementations, the composite material is in the form of a rectangular cuboid. In some implementations, the rectangular cuboid has dimensions of about 5 centimeters to 10 centimeters by about 10 centimeters to 100 centimeters by about 10 centimeters to 100 centimeters.

In some implementations, the composite material further includes a ceramic layer disposed on outer surfaces of the composite material. In some implementations, the ceramic layer is a ceramic coating from a group an oxide, a carbide, a boride, and a nitride. In some implementations, the ceramic layer is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TIN, HAN, ZrN, TaN, NbN, and VN. In some implementations, the ceramic layer has a thickness of about 0.1 millimeters to 5 millimeters.

In some implementations, the composite material further includes refractory metal particles dispersed in the ceramic. The refractory metal particles are refractory metal particles from a group tungsten, molybdenum, niobium, tantalum, and rhenium. In some implementations, the refractory metal particles are up to about 5 weight % of the composite material. In some implementations, a particle size of the refractory metal particles is about 100 nanometers to 1 millimeter.

Another innovative aspect of the subject matter described in this disclosure can be implemented in a method providing a ceramic, providing graphite flakes, mixing the ceramic and the graphite flakes to form a mixture, compressing the mixture to form a compressed solid, and sintering the compressed solid. Particles of the ceramic have sizes of about 500 nanometers to 40 microns. The graphite flakes have dimension of about 10 microns to 800 microns by about 10 microns to 800 microns by about 1 micron to 80 microns. The graphite flakes are about 20 weight % to 35 weight % of the mixture. Sintering the compressed solid includes heating the compressed solid at about 500° C./minute to 1500° C./minute, holding the compressed solid at about 1600° C. to 2400° C. for about 2 minutes to 8 minutes, and cooling the compressed solid at about 5° C./minute to 6000° C./minute.

In some implementations, the sintering is performed by positioning the mixture between two sheets of carbon paper and Joule heating the carbon paper.

Another innovative aspect of the subject matter described in this disclosure can be implemented in a method including providing a composite material, resistively heating the composite material to above about 1500° C., and transferring heat in the composite material to a heat transfer fluid. The composite material comprise a ceramic and graphite flakes dispersed in the ceramic. The ceramic serves as a matrix of the composite material. The ceramic is undoped. The ceramic is an oxide, a carbide, a boride, or a nitride. The graphite flakes are about 20 weight % to 35 weight % of the composite material. The composite material has porosity of about 5% to 40%.

In some implementations, after transferring the heat, the method further includes heating the composite material to above about 1500° C. In some implementations, the heat transfer fluid comprises a gas. In some implementations, the heat transfer fluid comprises argon.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an overview schematic showing how HT-TES converts renewable electrical energy to high temperature thermal energy (>1500° C.) and supplies heat and electricity to the end-user.

FIG. 2 shows the demonstrated cycle life of different thermal energy storage technologies plotted versus their maximum storage temperature. Filled symbols represent storage materials that require separate indirect heaters and the empty symbols represent materials that can be directly resistance heated. Note that higher storage temperatures allow for larger energy storage densities.

FIGS. 3A and 3C show SEM micrographs of a SiC+Gr pellet before and after sintering, respectively. FIG. 3B shows the recorded temperature evolution of the carbon heater during the sintering process.

FIG. 4A shows a SEM micrograph of a Vickers hardness test. FIG. 4B shows the measured Vickers hardness of all prepared pellets described herein, where the dashed line represents the measured hardness value of concrete for comparison. Error bars represent measurement errors in average length of the diagonal left by the indenter.

FIG. 5 shows a contour map showing the storage material heat utilization versus slab thickness, L, and material thermal conductivity, K. Plotted points show the maximum slab thicknesses that achieve at least 95% utilization for each corresponding material based on the predicted thermal conductivity.

FIG. 6 shows the measured temperature-dependent electrical conductivity of sintered composite pellets.

FIG. 7 shows the maximum stable slab thicknesses, L_{safemax}, as a function of temperature for different storage materials. Slab thicknesses smaller than L_{safemax} will dissipate hot spots and avoid thermal runaway.

FIG. 8 shows the measured room temperature electrical conductivity of the composite pellets before and after >753 thermal cycling (all with ˜35% volume percentage of graphite flake). Error bars represent the uncertainties in pellets thickness measurements.

FIG. 9 shows the measured room temperature thermal conductivity of the sintered pellets before and after >753 thermal cycles (all with ˜35% volume percentage of graphite flake). Error bars represent the standard deviation of three hot disk measurements.

FIG. 10 shows the measured average Volumetric Coefficient of Thermal Expansion (VCTE) for each phase within the composite pellets from 25° C. to 900° C. based on XRD results. Errors bars are mainly from the uncertainties in linear least square fitting.

FIG. 11A shows an example of a cross-sectional schematic illustration of a portion of the composite material. FIG. 11B shows an example of a first ceramic grain and a second ceramic grain with an angle between the two grains.

FIG. 12 shows an example of a cross-sectional schematic illustration of a block of the composite material with a ceramic layer disposed on surfaces of the block of the composite material.

FIG. 13 shows an example of a flow diagram illustrating a manufacturing process for a composite material.

FIG. 14 shows an example of a flow diagram illustrating a method of use of a composite material.

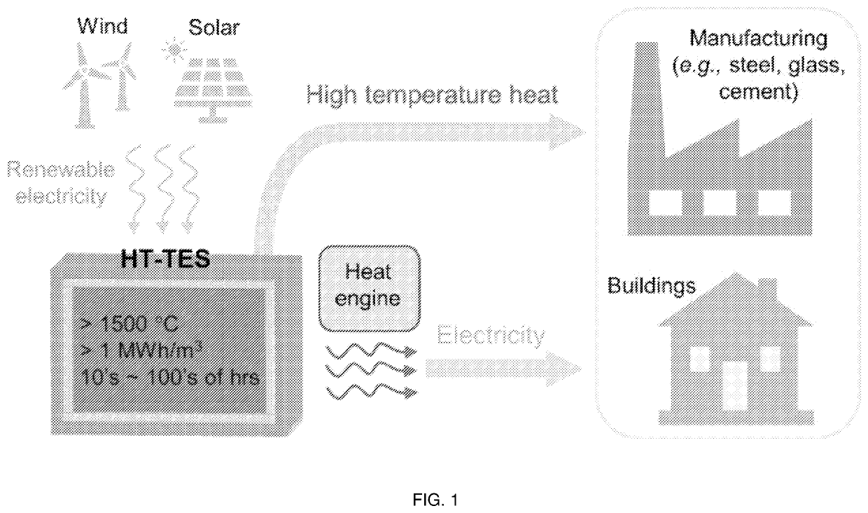

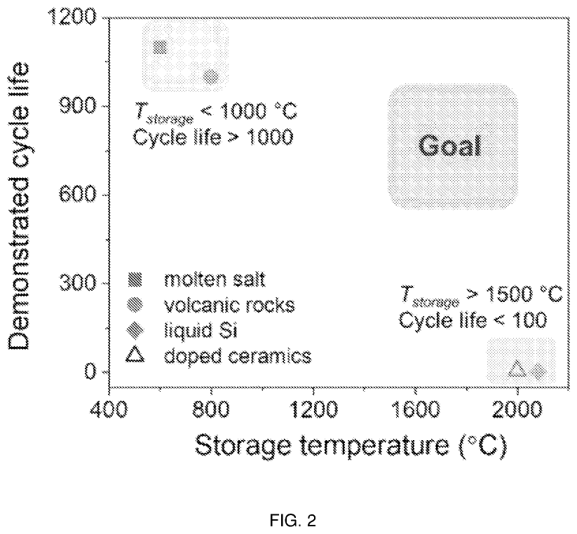

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Historically, the two most challenging HT-TES material properties to satisfy have been (1) rapid stable self-heating and (2) cyclability. Experiments therefore focused on creating these properties in ceramics as starting base materials that have otherwise desirable properties. Rapid stable self-heating requires a moderate level of electrical conductivity (˜1,000 S/m) without a strong temperature dependence to avoid thermal runaway that would lead to heating instabilities.

Graphite flake was chosen as a conductive filler to add to the ceramic matrix due to its overall weak temperature dependence resulting from its semimetal-like electronic band structure. Like ceramics, graphite flake is also abundant, safe, and remains solid at very high temperatures. In some embodiments, enough graphite flake was added to exceed the percolation threshold (˜33 vol %) based on the Bruggeman model. This helped ensured enough distributed graphite flake to reliably form random continuous conductive pathways throughout the composite, giving it good electrical conductivity. It also enhanced the composite's thermal conductivity, improving thermal stability, heat utilization, and maximum block thickness, as discussed later.

The composite also needs to withstand exposure to extreme spatial and temporal temperature gradients and survive repeated cycling of large temperature oscillations greater than 1,000° C. While brittle materials with low Young's Modulus and high tensile strength are resistant to thermal shock, they are highly susceptible to damage accumulation if thermal fracture does occur, resulting in catastrophic failure. In contrast, stiffer materials with lower tensile strength will fracture at smaller thermal strains but with less stored elastic energy, resulting in smaller and less devastating cracks.

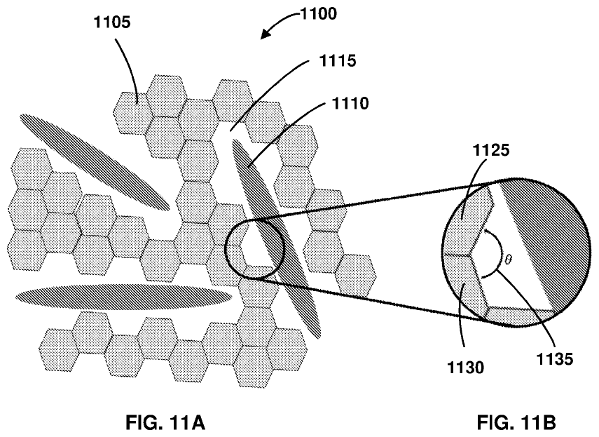

Described herein is a composite material that can be used as a high-temperature thermal energy storage material (HT-TES). The composite material is designed for use in a HT-TES system. FIG. 11A shows an example of a cross-sectional schematic illustration of a portion of the composite material.

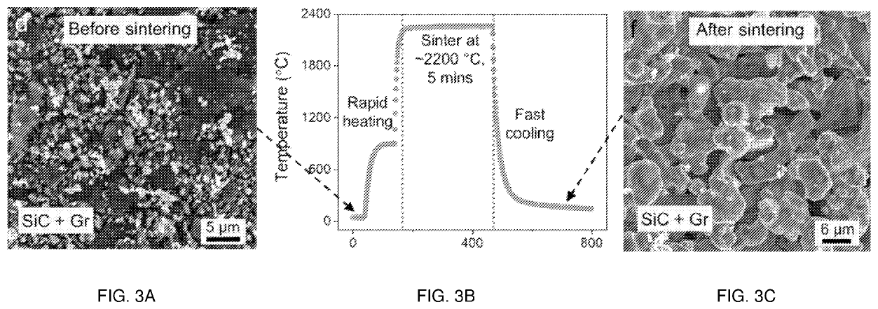

As shown in FIG. 11A, a composite material 1100 includes a ceramic made up of ceramic grains 1105 and graphite flakes 1110 dispersed in the ceramic. The ceramic serves as a matrix of the composite material. In some embodiments, the ceramic is an oxide, a carbide, a boride, or a nitride. In some embodiments, the graphite flakes are about 20 weight % to 35weight %, or about 25 weight %, of the composite material. In some embodiments, the composite material has a porosity of about 5% to 40%. A pore or open volume 1115 in the ceramic material is also shown in FIG. 11A. Pores form between the ceramic and graphite flakes disposed in the ceramic because of differences in the thermal expansion coefficients of the two different materials. FIG. 3C shows an example of an SEM micrograph of a composite material, specifically a SiC+Gr pellet.

In some embodiments, the ceramic is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TiN, HAN, ZrN, TaN, NbN, and VN. In some embodiments, the ceramic is an undoped ceramic. In some embodiments, a grain size of the ceramic is about 500 nanometers to 40 microns. In some embodiments, grains of the ceramic are joined to adjacent grains of the ceramic at about 110 degrees to 140 degrees. This angle is the angle at which one ceramic grain is relative to another ceramic grain after the ceramic grains are fused together after sintering. FIG. 11B shows an example of a first ceramic grain 1125 and a second ceramic grain 1130 with an angle 1135 between the two grains.

In some embodiments, each graphite flake of the graphite flakes has dimensions of about 10 microns to 800 microns by about 10 microns to 800 microns by about 1 micron to 8 microns. That is, in some embodiments, the graphite flake is an elongated graphite flake in some embodiments. In some embodiments, an average size the graphite flakes is about an order of magnitude larger than an average grain size of the ceramic. In some embodiments, an aspect ratio (i.e., thickness to length/width) or each graphite flake of the graphite flakes is about 1 to 10 to about 1 to 100. In some embodiments, the electrical conductivity of the graphite flakes does not vary significantly with temperature. In some embodiments, the graphite flakes are not graphene. In some embodiments, an average size of a pore in the composite material is less than an average size of the graphite flakes. In some embodiments, the graphite flakes form a random continuous electrically conductive pathway in the composite material. I.e., each graphite flake is in contact with at least one other graphite flakes when the graphite flakes are dispersed in the ceramic.

The graphite flakes in the composite material act as micromechanical thermal stress concentrators, nucleating a high density of uniformly distributed microcracks throughout the material when only a small amount of elastic energy has been accumulated (e.g., due to the difference between the coefficient of thermal expansion between the graphite flake and the ceramic during heating). These microcracks, along with the small but finite porosity, then act to volumetrically distribute absorption of the released elastic energy during fracture events so that no single crack grows large.

If thermal cycling of the composite material in an HT-TES system causes sintering that closes cracks or pores, the graphite flakes help to ensure consistent reforming of distributed microcracks in future cycling to limit maximum crack size. The small ceramic grain sizes mean that the comparatively large graphite flakes pin and deflect propagating cracks, further limiting damage accumulation. The resulting composite material can thus withstand exposure to extreme temperature gradients and many repeated thermal cycles without accumulating enough damage to significantly reduce its performance.

In some embodiments, the composite material has a thermal conductivity of about 2 Watts per meter-Kelvin (W/m-K) to 20 W/m-K, or about 2.5 W/m-K to 6 W/m-K. In some embodiments, the composite material has an electrical conductivity of about 1500 siemens per meter (S/m) to 3500 siemens per meter. In some embodiments, the electrical conductivity of the composite material does not vary significantly with temperature, which contributes in part to the stability of the composite material under Joule heating. With the electrical conductivity not varying significantly with temperature, the composite material is stable under Joule heating (i.e., resistive heating) and not subject to thermal runaway effects. The stability of the composite material under Joule heating is attributed in part to there being no increase in the thermal resistance between grains of the ceramic and the boundaries between the ceramic and the graphite flakes.

In some embodiments, a Vickers hardness of the composite material is greater than about 40 megapascals (MPa). A Vickers hardness of above about 40 MPa helps to ensure that blocks or bricks of the composite material that can support their own weight can be fabricated. In some embodiments, the composite material has a melting temperature higher than about 1500° C., about 1800° C., about 2000° C., or about 2250° C.

In some embodiments, the composite material is in the form of a rectangular cuboid (e.g., a block or a brick). For a rectangular cuboid, a type of three-dimensional shape, all angles are right angles and opposite faces of the cuboid are equal. In some embodiments, the rectangular cuboid has dimensions of about 5 centimeters to 10 centimeters by about 10 centimeters to 100 centimeters by about 10 centimeters to 100 centimeters.

In some embodiments, a ceramic layer is disposed on outer surfaces of the composite material. Such a ceramic layer can help to prevent graphite flakes from being exposed to air at high temperatures and subsequently oxidizing. In some embodiments, the ceramic layer is a ceramic from a group an oxide, a carbide, a boride, and a nitride. In some embodiments, the ceramic layer is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TIN, HAN, ZIN, TaN, NON, and VN. In some embodiments, the ceramic layer has a thickness of about 0.1 millimeters to 5 millimeters, or about 1 millimeter.

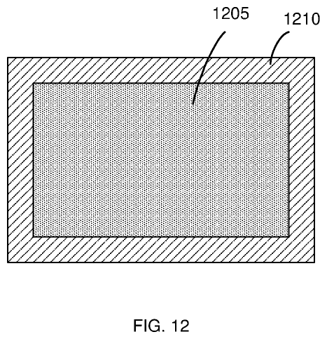

FIG. 12 shows an example of a cross-sectional schematic illustration of a block of the composite material with a ceramic layer disposed on surfaces of the block of the composite material. As shown in FIG. 12, a block of the composite material 1205 has a ceramic layer 1210 disposed thereon.

In some embodiments, the composite further comprises refractory metal particles dispersed in the ceramic. In some embodiments, the refractory metal particles are refractory metal particles from a group tungsten, molybdenum, niobium, tantalum, and rhenium. In some embodiments, the refractory metal particles are up to about 5 weight % of the composite material. In some embodiments, a particle size of the refractory metal particles is about 100 nanometers to 1 millimeter.

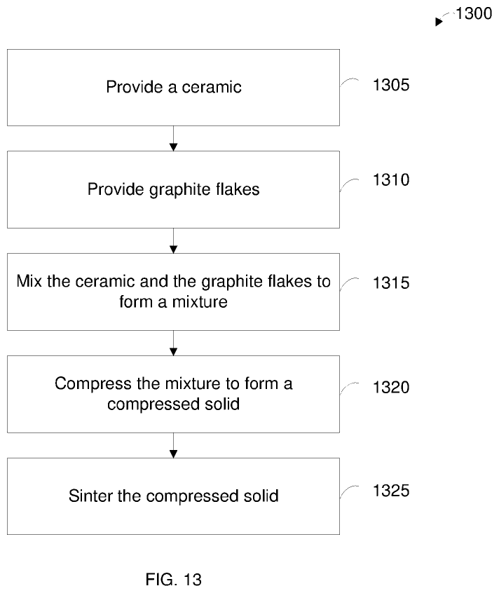

FIG. 13 shows an example of a flow diagram illustrating a manufacturing process for a composite material. The manufacturing process described with respect to FIG. 13 can be used to fabricate any of the composite materials described herein. Starting at block 1305 of the process 1300, a ceramic is provided. The ceramic is in the form of particles. In some embodiments, the particles have sizes of about 500 nm to 40 microns. In some embodiments, the ceramic particles are ball milled to reduce the particle size to a specified particle size.

At block 1310, graphite flakes are provided. In some embodiments, the graphite flakes have dimension of about 10 microns to 80 microns by about 10 microns to 80 microns by about 1 micron to 8 microns. In some embodiments, the graphite particles are ball milled to reduce the flake size to a specified flake size.

At block 1315, the ceramic and the graphite flakes are mixed to form a mixture. In some embodiments, the mixing includes ball milling the ceramic and the graphite flakes that are within the same container. In some embodiments, the graphite flakes are about 20 weight % to 35 weight % of the mixture.

At block 1320, the mixture is compressed to form a compressed solid. At block 1325, the compressed solid is sintered. In some embodiments, the sintering includes heating the compressed solid at about 500° C./minute to 1500° C./minute, or at about 1000° C./minute, holding the compressed solid at about 1600° C. to 2400° C., or at about 2200° C., for about 2 minutes to 8 minutes, or about 5 minutes, and cooling the compressed solid at about 5° C./minute to 6000° C./minute, or at about 5000° C./minute. In some embodiments, the compressed solid is cooled to room temperature.

In some embodiments, the sintering at block 1320 is performed by positioning the mixture between two sheets of carbon paper and Joule heating the carbon paper. Joule heating is the process by with current is passed through an electrical conductor, producing heat; i.e., the electrical conductor heats up.

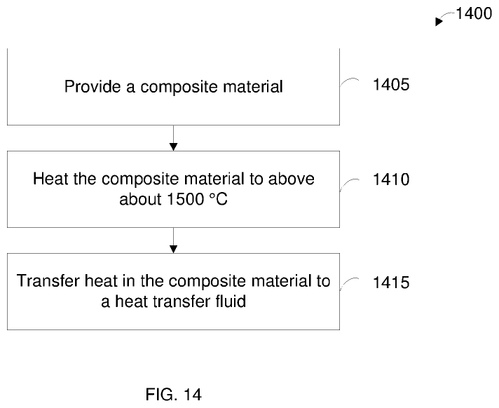

FIG. 14 shows an example of a flow diagram illustrating a method of use of a composite material. Starting at block 1405 of the method 1400 shown in FIG. 14, a composite material is provided. The composite material may be any of the composite materials described herein.

At block 1410, the composite material is resistively heated to above about 1500° C. In some embodiments, the composite material is resistively heated to above about 1800° C. the composite material is resistively heated to above about 2000°° C. The energy used to heat the composite material is stored as heated in the composite material.

At block 1415, the heat in the composite material is transferred to a heat transfer fluid. In some embodiments, the heat transfer fluid comprises a gas. In some embodiments, the heat transfer fluid comprises argon. To transfer the heat to the heat transfer fluid, the heat transfer fluid may be flowed around the composite material.

The process 1400 can be repeated to use the composite material to store energy. For example, after transferring the heat to the heat transfer fluid, the composite material is again heating to above about 1500° C.

In some embodiments, the composite material does not include graphite flakes. In some embodiments, the composite material includes a ceramic and refractory metal particles dispersed in the ceramic. The ceramic serves as a matrix of the composite material. In some embodiments, the ceramic is an undoped ceramic. In some embodiments, the ceramic is an oxide, a carbide, a boride, or a nitride. In some embodiments, the ceramic is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TiN, HAN, ZrN, TaN, NbN, and VN. In some embodiments, the refractory metal particles are about 60 weight % to 90 weight % of the composite material. In some embodiments, the composite material has porosity of about 5% to 40%.

In some embodiments, the refractory metal particles are refractory metal particles from a group tungsten, molybdenum, niobium, tantalum, and rhenium. In some embodiments, a particle size of the refractory metal particles is about 100 nanometers to 1 millimeter.

The following examples are intended to be examples of the embodiments disclosed herein, and are not intended to be limiting.

### Example-Storage Material Synthesis

TiO₂, MgO, and SiC were evaluated as candidate composite matrix materials owing to these ceramics' high melting temperatures (>1800° C.), low cost, and chemical inertness. Pure ceramic powders were mixed with the graphite flakes, pressed into pellets, and sintered using an ultrafast high-temperature sintering (UHS) technique previously developed, as described in more detail in the following example.

During sintering the 100's of nm sized ceramic powder particles coalesced into grains of several microns in diameter (see FIGS. 3A-3C), while the graphite flakes did not sinter and retained their original tens of microns size. The average volumetric fill fraction increased from 48±4% to 73±2%, leaving a porosity low enough to preserve good energy density and thermal and electrical conductivities, but high enough to help mitigate thermal cycling fatigue by acting as microcracks as noted above. As indicated by X-ray photoelectron spectroscopy (XPS) results, the densification is achieved due to the additional chemical driving force beyond the normal capillary force using this UHS technique.

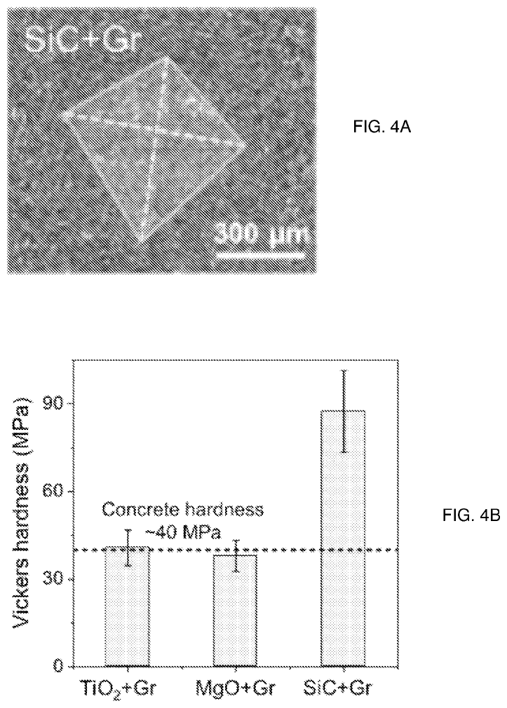

All HT-TES critical properties were quantified using the same samples and evaluated regarding how these could impact the design of a full-scale system. All three composites satisfied HT-TES requirements with SiC+Gr exhibiting the best all-around performance, which was then subjected to more rigorous testing and investigations. Vickers hardness tests (see FIGS. 4A and 4B) showed that the composites all achieved a mechanical hardness comparable to or higher than that of concrete (40-50 MPa), showing great promise for structural TES blocks that can support their own weight. Heat capacity measurements and theoretical extrapolation to high temperatures confirmed high energy densities in the range of 0.87-1.03 MWh/m³ (ΔT=1000° C.). The thermal conductivities, K, at room temperature were 2.9 W/m-K (TiO₂+Gr), 3.6 W/m-K (MgO+Gr), and 5.9 W/m-K (SiC+Gr), which were comparable to or better than various types of rocks successfully used in lower temperature TES studies such as granite (2.8 W/m-K), basalt (3.2 W/m-K), and hornfels (1.5 W/m-K).

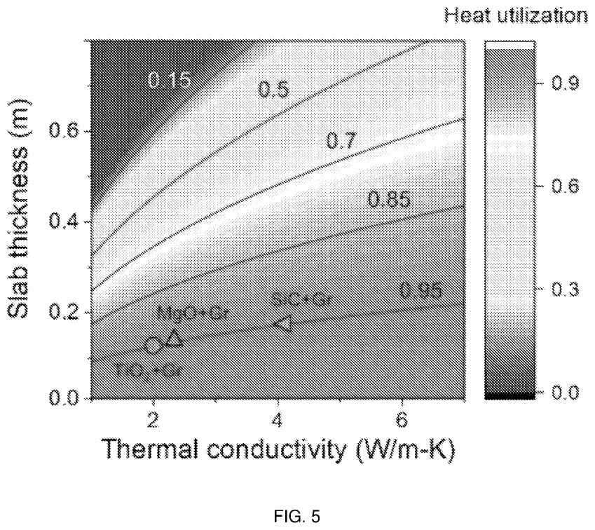

Using an asymmetric effective medium Bruggeman's model, the measured room temperature thermal conductivity was extrapolated to 1,500° C. based on literature data for temperature dependencies of each component and considering the effects of interfacial thermal resistance. Thermal conductivity directly affects charging stability and HT-TES power density. Furthermore, when discharging a full-scale HT-TES system, a heat transfer fluid (e.g., Ar gas) convectively extracts heat from the storage blocks, creating internal temperature gradients that supply the necessary application-dictated heat flux as the blocks cool. The discharge process is stopped when the heat extracted falls below the minimum useful application temperature. However, even in this final discharged state, the blocks may retain inaccessible residual heat due to their internal temperature gradients, reducing the system's effective energy density and resulting in less than 100% heat utilization. Blocks with larger K will have smaller temperature gradients and thus better heat utilization. To achieve heat utilizations >95%, an HT-TES system sized to supply 12 hours of continuous power would need to use storage blocks no thicker than about 13 cm (TiO₂+Gr) to 17 cm (SiC+Gr) in the direction of heat flux (see FIG. 5) based on the predicted temperature-dependent K. These composites therefore allow for practical block geometries amenable to industrial scale manufacturing and installation. Thicker blocks are possible in systems designed for longer durations of supplied power (e.g., about 100 hours).

### Example—Ultrafast High-Temperature Sintering (UHS) Using Carbon Heaters

The raw materials of ceramic powders (about 100 nm to 300 nm particle size) and graphite flakes (about 5 μm to 10 μm flake size) were first mixed with ball-milling and the precursor powders were then pressed into pellets with a die using a hydraulic pressing tool. The ultrafast high-temperature sintering (UHS) was conducted in an argon filled chamber, and the heating rate and temperature of the Joule-heated carbon strip were controlled by tuning the voltage of the power supply. The geometry of the carbon strips was designed to match the heater resistance with the current and voltage limits of the power supply to achieve the heating power and sintering temperature. Three pieces of carbon strips with designed geometries were used as the heater for the sintering process, with three pressed pellets sandwiched between the heater strips being rapidly heated via thermal radiation and conduction. Using this method, a high heating rate of about 10³° C./min, a cooling rate up to about 5×10³° C./min, and a high sintering temperature of about 2200° C. were achieved (see FIG. 3B).

Similar to conventional spark plasma sintering, the ultrahigh heating rates of the UHS technique enhances the densification rate. The ultra-fast sintering also minimizes cross-diffusion between the components to maintain the structural integrity, and the distinct phases forming the dense composite pellets are directly shown in the EDS elemental mapping of the sintered composite pellets. The temperature of the heater was measured using a two-color pyrometer with uncertainty of ±1° C. The relative density of the sintered pellets is defined as 1-porosity, where the porosity is calculated based on the measured weight, volume, and the component intrinsic material density.

### Example—Rapid Stable Self-Heating

The electrical conductivities, σ, of the composites at room temperature were 3,382 S/m (TiO₂+Gr), 1,601 S/m (MgO+Gr), and 2,643 S/m (SiC+Gr), which are 10 to 100 times higher than the pure semiconductor ceramic components of TiO₂ (17.1 S/m) and SiC (362 S/m), and nearly 10,000 times higher than related doped Cr₂O₃. These values confirm the percolation threshold was achieved in all composites. For a representative 800 MW direct-reduction iron plant, 9,600 MWh of stored energy would be needed to provide 12 hours of continuous power. For these composites' electrical conductivities, such a system could be fully charged in 6 hours using an industrial charging voltage of 480 V, which could exploit the daily low-cost electricity window.

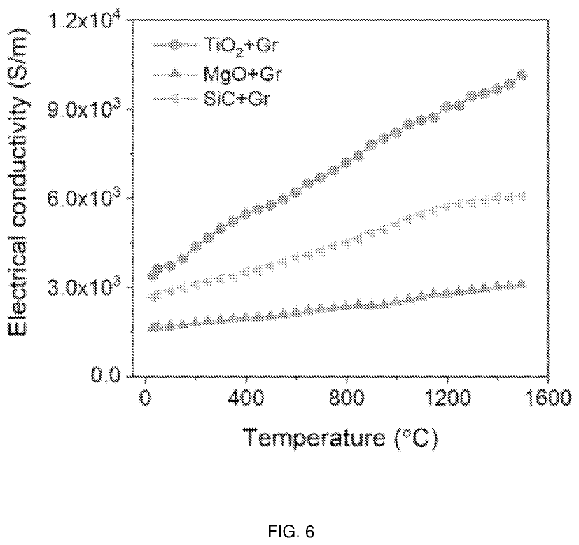

σ as a function of temperature was also measured up to operational HT-TES temperatures and confirmed that all composites have a relative Temperature Coefficient of Conductivity (TCC) magnitude less than 0.01 K⁻¹, meaning their electrical conductivity changes by less than 1% per degree change in temperature (see FIG. 6). In contrast, HT-TES doped ceramics' relative TCC is ˜1,000× larger within the same temperature range.

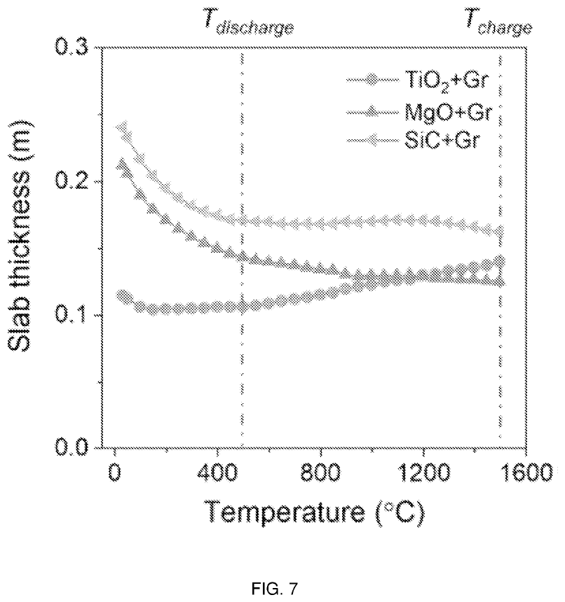

TCC magnitude is important for stability and safety during charging. If random fluctuations produce a hot spot during charging, a sufficiently large positive or negative TCC will cause local heat generation to intensify in a positive feedback loop leading to thermal runaway and catastrophic failure. The TCC's sign determines whether such risk is associated with parallel or series current flow, both of which exist in 3D self-heated blocks. The composites have a slight positive TCC, putting them at risk of failure in parallel configurations. However, a small TCC can still be tolerated if heat passively conducts away from the hot spot faster than it is generated (see FIG. 7). Based on the composites' measured κ and TCC, the maximum allowable block thickness, L_{safemax}, below which heat will always conduct away fast enough to prevent thermal runaway for hot spots of any size, was calculated. For these composites, L_{safemax} varies from 11 cm (TiO₂+Gr) to 17 cm (SiC+Gr) in the direction perpendicular to electrical current flow (see FIG. 7), in alignment with the thermal utilization thickness.

To evaluate the practicality of the idea and show the self-heating capability, a proof of concept device was developed. A thermal soak-and-hold test by self-heating a SiC+Gr composite sample to 1,936° C. and holding it there for over an hour was performed, during which the sample did not exhibit any temperature instabilities or degradation.

### Example—Thermal Cycling Fatigue Resistance

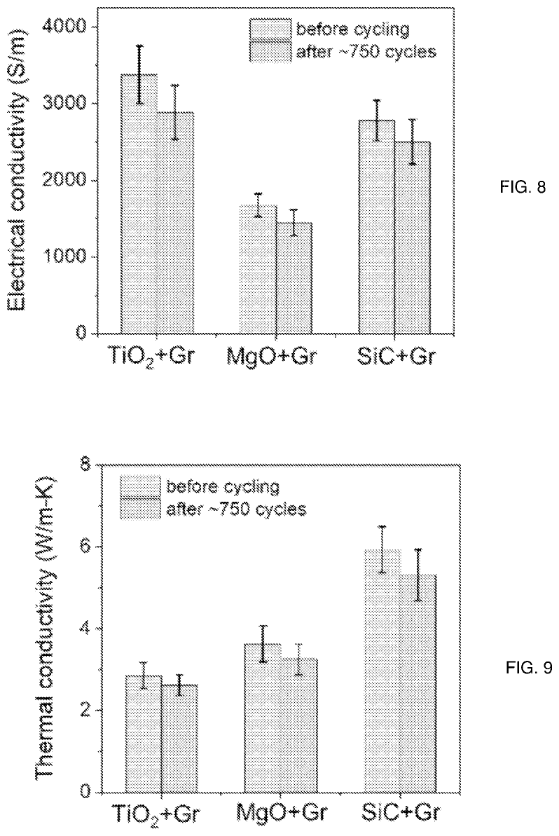

To evaluate the thermal cycling stability of the composites, σ and κ were measured before and after thermally cycling each sample ˜750 times (see FIGS. 8-10). Each cycle constituted ramping the sample up from 500° C. to 1,630° C. and back down again in 3 minutes, creating spatial and temporal temperature gradients comparable to or greater than what would be experienced in a full-scale HT-TES system. Additionally, intermediate values of σ were measured every few 10's to 100's of cycles to track degradation. FIGS. 8 and 9 show that all composites' transport properties remained stable with <14% throughout thermal cycling. This initial reduction occurred after the first cycle and then there was negligible degradation over the hundreds of remaining cycles tested, indicating robust thermal cycling fatigue resistance and the potential to survive decades-long service life. An Al₂O₃+Gr composite was also evaluated, but it experienced complete fracture failure during cycling, possibly due to a high temperature chemical reaction between alumina and graphite flake that produced trapped carbon monoxide gas, which built up pressure until failure.

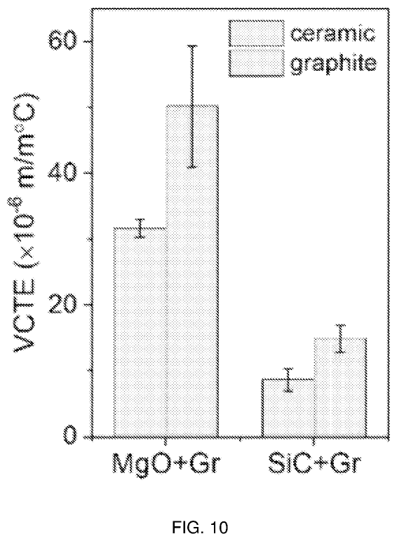

To verify the microscopic mechanisms enabling this thermal stability, high temperature X-Ray Diffraction (XRD) from 25° C. to 900° C. was performed on the SiC+Gr and MgO+Gr samples (see FIG. 10). Chemical phase transition of the titania phase in the TiO₂+Gr sample complicated its XRD data analysis (confirmed by XPS measurements). As noted earlier, the graphite flakes function as micromechanical thermal stress concentrators to encourage formation of a high density of uniformly distributed benign microcracks rather than fewer catastrophically large cracks during thermal fracture events. This stress concentration would necessitate thermal strain mismatches between the graphite flake and ceramic phases and would produce stress gradients within the graphite flake during heating. Both of these features were corroborated by the XRD data. XRD measures thermal expansion of each component of each composite from the temperature-dependent shift in its diffraction peak. The Volumetric Coefficient of Thermal Expansion (VCTE) of the graphite phase was found to be mismatched with that of the corresponding ceramic phase by roughly a factor of two in both samples (see FIG. 10). The relative increase of the graphite phase diffraction peak widths with temperature to be of order 10⁻⁴ K⁻¹ (tens of percent increases over cycling temperatures) was also measured. Given the cm-sized X-Ray spot size used and the tens of microns-sized graphite flakes, this diffraction peak broadening reveals increasingly heterogeneous strain in the graphite flake and hence thermal stress concentration from heating.

While all composites satisfied all HT-TES requirements, SiC+Gr enables the largest and most stable storage blocks in a real system, making it the preferred composite of the composites fabricated in this study. High temperature in-situ Transmission Electron Microscope (TEM) videography on SiC+Gr was performed to investigate the dynamic microstructural changes during heating from 25° C. to 1,000° C. The TEM videos confirmed that the existing pores and microcracks are able to accommodate significant thermal strain, preventing further crack propagation.

### Conclusion

Further details regarding the embodiments described herein can be found in Peng Peng et al., “Techno-economic Analysis of High-Temperature Thermal Energy Storage for On-Demand Heat and Power,” 18 Jan. 2022, Version 2, published on ChemRxiv.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A composite material comprising:
a ceramic, the ceramic serving as a matrix of the composite material, the ceramic being an oxide, a carbide, a boride, or a nitride; and
graphite flakes dispersed in the ceramic, the graphite flakes being about 20 weight % to 35 weight % of the composite material, the composite material having porosity of about 5% to 40%.

2. The composite material of claim 1, wherein the ceramic is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TiN, HfN, ZrN, TaN, NbN, and VN.

3. The composite material of claim 1, wherein the ceramic is an undoped ceramic.

4. The composite material of claim 1, wherein a grain size of the ceramic is about 500 nanometers to 40 microns.

5. The composite material of claim 1, wherein grains of the ceramic are joined to adjacent grains of the ceramic at about 110 degrees to 140 degrees.

6. The composite material of claim 1, wherein each graphite flake of the graphite flakes has dimensions of about 10 microns to 800 microns by about 10 microns to 800 microns by about 1 micron to 8 microns.

7. (canceled).

8. The composite material of claim 1, wherein the graphite flakes form a random continuous electrically conductive pathway in the composite material.

9. The composite material of claim 1, wherein the composite material has a thermal conductivity of about 2 Watts per meter-Kelvin (W/m-K) to 20 Watts per meter-Kelvin.

10. The composite material of claim 1, wherein the composite material has an electrical conductivity of about 1500 siemens per meter (S/m) to 3500 siemens per meter.

11. (canceled).

12. The composite material of claim 1, wherein the composite material has a melting temperature higher than about 1500° C.

13. The composite material of claim 1, wherein the composite material is in the form of a rectangular cuboid, and wherein the rectangular has dimensions of about 5 centimeters to 10 centimeters by about 10 centimeters to 100 centimeters by about 10 centimeters to 100 centimeters.

14. The composite material of claim 1, further comprising:
a ceramic layer disposed on outer surfaces of the composite material.

15. The composite material of claim 14, wherein the ceramic layer is a ceramic coating from a group an oxide, a carbide, a boride, and a nitride.

16. The composite material of claim 14, wherein the ceramic layer is a ceramic from a group TiO₂, MgO, Al₂O₃, SiC, TaC, TiC, ZrC, HfC, NbC, VC, TiB₂, ZrB₂, TiB₂, HfB₂, NbB₂, TaB₂, BN, TiN, HAN, ZrN, TaN, NbN, and VN.

17. The composite material of claim 14, wherein the ceramic layer has a thickness of about 0.1 millimeters to 5 millimeters.

18. The composite material of claim 1, further comprising:
refractory metal particles dispersed in the ceramic, wherein the refractory metal particles are refractory metal particles from a group tungsten, molybdenum, niobium, tantalum, and rhenium.

19. The composite material of claim 18, wherein the refractory metal particles are up to about 5 weight % of the composite material.

20. (canceled).

21. A method comprising:
providing a ceramic, particles of the ceramic having sizes of about 500 nanometers to 40 microns;
providing graphite flakes, the graphite flakes having dimension of about 10 microns to 800 microns by about 10 microns to 800 microns by about 1 micron to 80 microns;
mixing the ceramic and the graphite flakes to form a mixture, the graphite flakes being about 20 weight % to 35 weight % of the mixture;
compressing the mixture to form a compressed solid; and
sintering the compressed solid, including heating the compressed solid at about 500° C./minute to 1500° C./minute, holding the compressed solid at about 1600° C. to 2400° C. for about 2 minutes to 8 minutes, and cooling the compressed solid at about 5° C./minute to 6000° C./minute.

22. The method of claim 21, wherein the sintering is performed by positioning the mixture between two sheets of carbon paper and Joule heating the carbon paper.

23. A method comprising:
providing a composite material, the composite material comprising:
a ceramic, the ceramic serving as a matrix of the composite material, the ceramic being undoped, the ceramic being an oxide, a carbide, a boride, or a nitride, and
graphite flakes dispersed in the ceramic, the graphite flakes being about 20 weight % to 35 weight % of the composite material, the composite material having porosity of about 5% to 40%;
resistively heating the composite material to above about 1500° C.; and
transferring heat in the composite material to a heat transfer fluid.

24-26. (canceled)
